(19) United States
(12) Patent Application Publication
(10) Pub. No.: US 2016/0141088 A1
(43) Pub. Date: May 19, 2016

(54) MAGNETIC COMPONENT

(71) Applicant: DELTA ELECTRONICS, INC., Taoyuan City (TW)

(72) Inventors: Ming-Hui DAI, Taoyuan City (TW); Jin-Ping ZHOU, Taoyuan City (TW); Min ZHOU, Taoyuan City (TW)

(21) Appl. No.: 14/731,425

(22) Filed: Jun. 5, 2015

(30) Foreign Application Priority Data
Nov. 17, 2014 (CN) 201410657907.5

(51) Int. Cl. H01F 27/24; H01F 27/32; H01F 27/28

(52) U.S. Cl. CPC H01F 27/24; H01F 27/2823; H01F 27/325; H01F 27/323

(57) ABSTRACT

A magnetic component includes a magnetic core, a winding, and a magnetic piece. The magnetic core includes at least one magnetic column, a top cover, and a bottom cover. The magnetic column is disposed between the top cover and the bottom cover, and an air gap is formed between the top cover and the magnetic column. The winding is wound on the magnetic column. The magnetic piece is disposed between the winding and the air gap, and the magnetic piece is arranged parallel to the air gap.

### RELATED APPLICATIONS

This application claims priority to China Application Serial Number 201410657907.5, filed Nov. 17, 2014, which is herein incorporated by reference.

### BACKGROUND

1. Field of Invention

The present invention relates to a magnetic component.

2. Description of Related Art

With rapidly developments of wind powers, solar powers, vehicle electronics, power module having high-frequency and high power density, or the likes, the requirements, such as volume, efficiency, and power density, for the magnetic components, such as inductors and transformers, in the power electronic device are higher and higher. The magnetic component has a magnetic core, and the magnetic core can be made of magnetic powder material with lower permeability, such as a Fe—Si magnetic powder core, a Fe-Sl-Ni magnetic powder core, or the likes. The magnetic core can be made of a magnetic material with higher permeability, such as ferrite, amorphous, silicon steel or the likes. When the magnetic core is made of high permeability material, such as ferrite, an air gap is formed on the magnetic core to bear the magnetic pressure and prevent the magnetic component from saturation. However, the magnetic field in the window of the ferrite magnetic core is not uniform, and the magnetic flux at the air gap may diffuse to the window thereby generating huge eddy current loss. In the cases of magnetic components using the planar winding, the diffused magnetic flux is vertical to the longwise side of the planar winding, such situation may raise huge eddy current loss.

### SUMMARY

The present disclosure provides a magnetic component having a magnetic piece disposed between the air gap and the winding to change the magnetic field distribution in the window and reduce the loss of the magnetic component.

An aspect of the disclosure provides a magnetic component, which includes a magnetic core, a winding, and a magnetic piece. The magnetic core includes at least one magnetic column, a top cover, and a bottom cover. The magnetic column is disposed between the top cover and the bottom cover, and an air gap is formed between the top cover and the magnetic column. The winding is wound on the magnetic column. The magnetic piece is disposed between the winding and the air gap, and the magnetic piece is arranged parallel to the air gap.

The present disclosure provides a magnetic component having a magnetic piece disposed between the air gap and the winding and is parallel to the magnetic air gap direction. The length of the magnetic piece, which is parallel to the air gap direction, is longer than the width of the magnetic piece, which is vertical to the air gap direction. The relative initial permeability of the magnetic piece is greater than 1. The magnetic component can change the magnetic field distribution in the window by adding the magnetic piece between the air gap and the winding, such that the loss of the magnetic component can be reduced.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a cross-sectional view taken along a direction parallel to a magnetic flux of a conventional magnetic component;

FIG. 2 is a cross-sectional view along a direction parallel to a magnetic flux of a magnetic component of the disclosure;

FIG. 3 is a diagram of a trend of the magnetic field intensity of the top surface of the winding in FIG. 2;

FIG. 4A, FIG. 4B and FIG. 5 are partially enlarged views of different embodiments of the magnetic component of the disclosure;

FIG. 6 and FIG. 7 are cross-sectional schematic views of different embodiments of the magnetic component taken along the direction parallel to the flux direction;

FIG. 8 and FIG. 9 are cross-sectional schematic views of different embodiments of the magnetic component taken along a direction vertical to the flux direction; and

FIG. 10 is a cross-sectional view of yet another embodiment of the magnetic component taken along the direction parallel to the flux direction.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

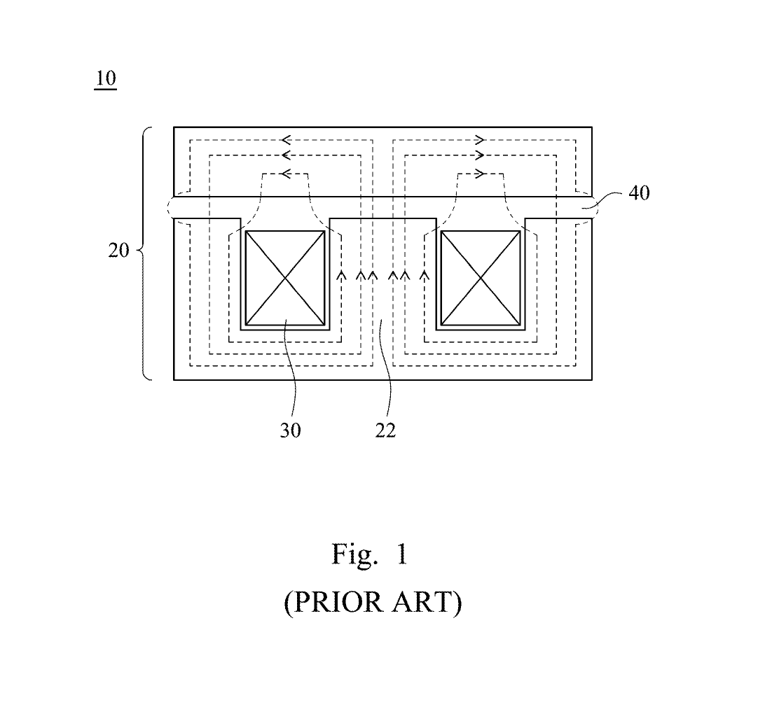

FIG. 1 is a cross-sectional view taken along a direction parallel to a magnetic flux of a conventional magnetic component. The magnetic component 10 includes an El type magnetic core 20, and a winding 30 wound on a middle column 22 of the magnetic core 20. The dotted line loop represents the magnetic flux of the magnetic component, and the arrow shows the direction of the magnetic flux, in which the magnetic flux direction is changed related to a current. The intensity of the magnetic field is stronger at the place close to the air gap 40 since the intensity of the magnetic field is weaker at the place close to the magnetic core 20. The magnetic flux is diffused into the window when the magnetic flux passes through the air gap, such that a problem of eddy current loss is raised.

Some industries use a litz wire with thinner diameter as the winding for solving such problem, but the litz wire has poor filling rate and expends a long time to wind. Some industries use low permeability magnetic core for solving such problem, but the low permeability magnetic core such as the magnetic core made of a magnetic powder material has huge loss than the magnetic core made of a ferrite material. Some industries use magnetic core made of ferrite material having distributed air gaps for solving such problem, but the processes of fabricating the magnetic core having plural air gaps are complicated and time consuming. Some industries make the winding wound away from the air gap, the volume of the magnetic core is increased.

Therefore, the present disclosure provides a design of the magnetic component. By using the magnetic component, the eddy current loss is reduced without increasing the volume of the magnetic core and complexity of the fabricating processes.

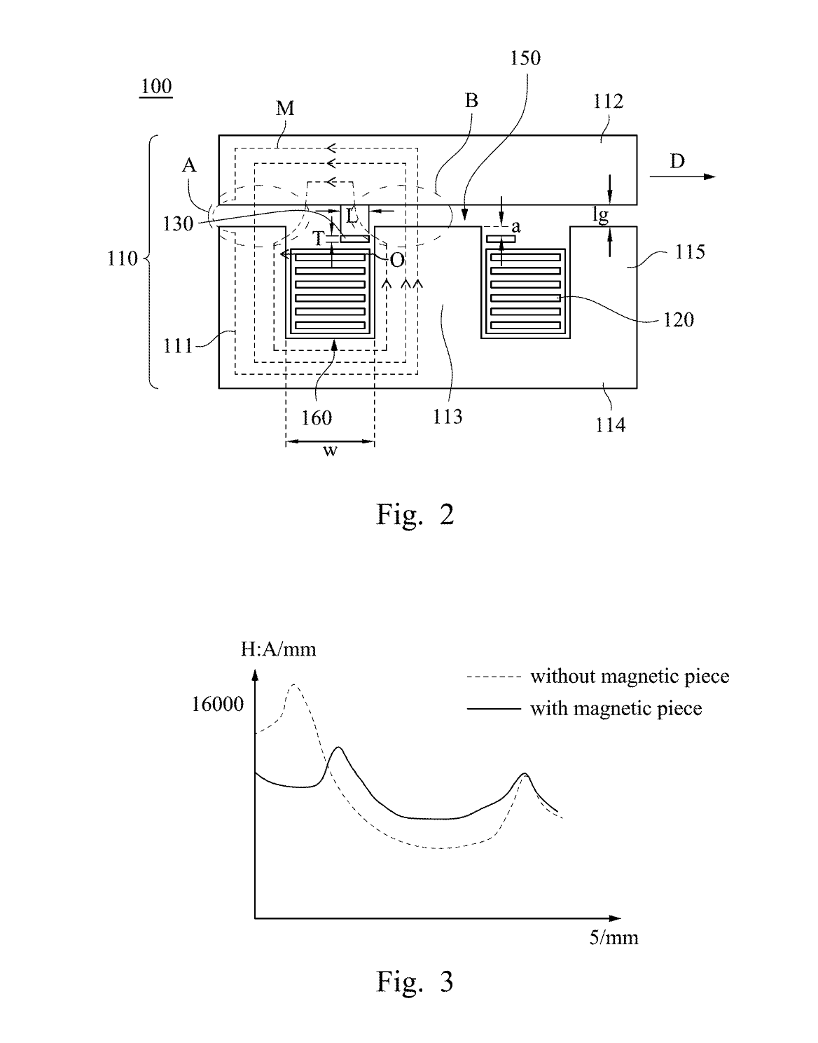

FIG. 2 is a cross-sectional view along a direction parallel to a magnetic flux of a magnetic component of the disclosure. The magnetic component 100 includes a magnetic core 110, a winding 120, and a magnetic piece 130. In this embodiment, the magnetic core 110 is an El type magnetic core, which includes a top cover 112, a bottom cover 114, and a plurality of magnetic columns 111, 113, 115 connected to the bottom cover 114. The top cover 112, the bottom cover 114, and the magnetic columns 111, 113 construct a magnetic flux M, and the top cover 112, the bottom cover 114, and the magnetic columns 113, 115 construct another magnetic flux (not shown). The direction of the magnetic flux M is changed related to the current. The El type magnetic core has a property of symmetry, therefore only the magnetic flux M at the left portion is illustrated in the figure.

An air gap 150 is formed between the top cover 112 and the magnetic columns 111, 113, 115. The magnetic columns include a left column 111, a middle column 113, and a right column 115 arranged sequentially. The winding 120 is wound on the middle column 113. The magnetic piece 130 is in a shape of ring, and the middle column 113 is surrounded by the magnetic piece 130. The magnetic piece 130 is disposed between the air gap 150 and the winding 120, and the magnetic piece 130 is arranged parallel to the direction of the air gap 150.

The air gap 150 is a space formed between the top cover 112 and the magnetic columns 111, 113, 115, such that the top cover 112 is spaced from the magnetic columns 111, 113, 115 by air. The air gap 150 can be regarded as a planar air layer, and the magnetic piece 130 is arranged parallel to the air gap 150. Namely, the direction of the magnetic flux M passing the air gap 150 is perpendicular to the direction of the air gap 150. More particularly, the air gap 150 has an air gap direction D, which is the direction of the plane of the air gap 150 located on. The arrangement of the magnetic piece 130 is parallel to the air gap direction D and is perpendicular to the magnetic flux direction of the magnetic flux M at the air gap 150.

A plurality of windows 160 are defined between the top cover 112, the bottom cover 114, and the neighbor two of the magnetic columns 111, 113, and 115. In this embodiment, a window 160 is defined between the top cover 112, the bottom cover 114, the left columns 111, and the middle column 113; another window 160 is defined between the top cover 112, the bottom cover 114, the middle column 113, and the right column 115.

One of the functions of the magnetic piece 130 is to reduce the eddy current loss due to the magnetic flux M diffusing into the window 160 when the magnetic flux M passes through the air gap 150. Details thereof are discussed in FIG. 3, which is a diagram of a trend of the magnetic field intensity of the top surface of the winding 120, in which the solid line represents the winding 120 with the magnetic piece 130 arranged thereon, and the dotted line represents the winding 120 without magnetic piece 130 arranged thereon.

The lateral axis in FIG. 3 represents the lateral distance counted from the origin point 0, in which the origin point 0 is a point where a line of the effective conductor portion of the winding 120 extending to the middle column 113 intersects the middle column 113. The vertical axis in FIG. 3 represents the magnetic field intensity. If the width w of the window 160 in the magnetic core 110 is about 5 mm, as shown by the dotted line in the figure, the magnetic field intensity is rapidly decreased since the distance to the origin point 0 is increased. Namely, the magnetic field intensity is changed rapidly when the distance is increased. The reasons include the reluctance of the air gap 150 is greater than that of the magnetic core 110, such that the magnetic field intensity near the air gap 150 is much greater than the magnetic field intensity near the magnetic core 110. Therefore the eddy current loss of the winding is huge.

As shown by the solid line in the figure, after the magnetic piece 130 is arranged, the magnetic field intensity near the magnetic piece 130, which is also near the original point 0, is observably reduced. Furthermore, the magnetic flux direction at the position A (see FIG. 2) the magnetic field intensity has a large component vertical to the winding 120. The magnetic field vertical to a longwise direction of the winding 120 raises huge eddy current loss, in which the longwise direction is parallel to the air gap direction D. After the magnetic piece 130 is arranged, the magnetic piece 130 can shield and block the magnetic field vertical to the longwise direction of the winding 120. As illustrated at the position B in FIG. 2, the magnetic field direction thereof would almost parallel to the surface of the winding 120, such that the eddy current loss of the winding 120 can be reduced. FIG. 2 shows that the magnetic flux M near the magnetic piece 130 is substantially parallel to the winding 120, and the magnetic field intensity direction is same as the magnetic flux direction.

The relative initial permeability of the magnetic piece 130 is greater than 1, such that the magnetic piece 130 can be distinguished from air to change the direction of the magnetic flux M near the air gap 150 and reduce the magnetic field intensity near the magnetic piece 130. If the relative initial permeability of the magnetic piece 130 is too small and is similar to that of the air, the efficiency of the magnetic piece 130 is poor. If the relative initial permeability of the magnetic piece 130 is too large, the magnetic field intensity at other position within the window 160 is increased while the magnetic field intensity near the magnetic piece 130 is reduced, which is also unfavorable for reducing the eddy current loss. In some embodiments, the relative initial permeability of the magnetic piece 130 is in a range between about 5 and about 30.

Reference is still made back to FIG. 2. At the dimension vertical to the air gap direction D, the distance from the magnetic piece 130 to the air gap 150 affects the magnetic field distribution in the window 160, the inductance of the magnetic component 110, and the loss of the magnetic piece 130. If the size at the dimension of the magnetic piece 130 parallel to the air gap direction D is regarded as a length L of the magnetic piece 130, the size at the dimension of the magnetic piece 130 vertical to the air gap direction D is regarded as a thickness T of the magnetic piece 130. The length L of the magnetic piece 130, which is parallel to the air gap direction D, is greater than the thickness T of the magnetic piece 130, which is vertical to the sir gap direction D. In this embodiment, the cut plane shape of the magnetic piece 130 can be a rectangle, in which the cut plane is the plane of the magnetic piece 130 vertical to the air gap direction D. Namely, the cut plane of the magnetic piece 130 is cut at the plane parallel to the magnetic flux M. The cut plane can also be regarded as the plane viewed from a side of the magnetic piece 130. In other embodiments, the cut plane shape of the magnetic piece 130 can be an ellipse, a rhombus, or any other suitable shape.

The distance from the magnetic piece 130 to the air gap 150 is regarded as a shortest distance of a the magnetic piece 130 to the air gap 150 vertical to the air gap direction D. The length L and the thickness T of the magnetic piece 130 have influences to the magnetic field distribution in the window 160, the inductance of the magnetic component 100, and the eddy current loss of the magnetic piece 130.

In order to achieve the purpose of reducing loss of the winding 120 by pacing the magnetic piece 130 and without changing the inductance, the parameters aforementioned can be designed. For example, the length L of the magnetic piece 130 is about 0.1 to about 0.5 times of the window width w, i.e., the ratio of the length L of the magnetic piece 130 to the width w of the window 160 is about 0.1 to about 0.5; the ratio of the thickness T to the air gap length lg is about 0.2 to about 3; the vertical distance from the magnetic piece 130 to the air gap 150 is about 0 to about 5 times of the air gap length lg, in which the width w of the window 160 is a distance of the window extended along the air gap direction D, the air gap length lg is the length of the air gap 150 along the direction of flux at the air gap 150. The distance between the magnetic piece 130 and the top cover 112 is greater than or equal to the air gap length lg.

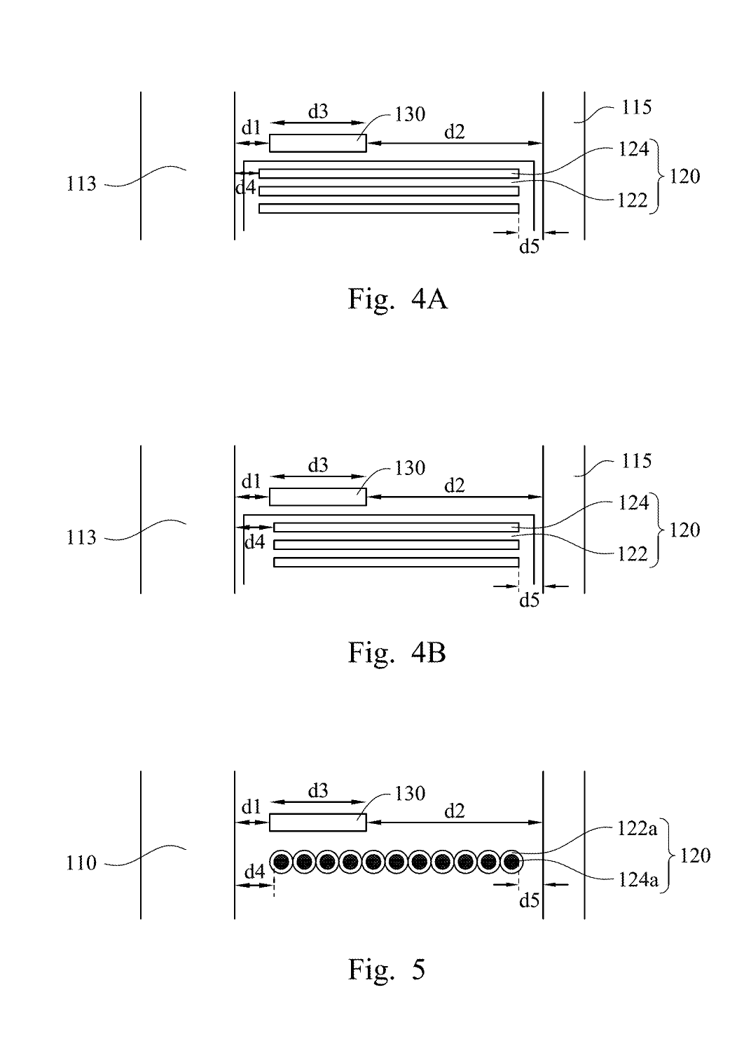

FIG. 4A is a partially enlarged view of an embodiment of the magnetic component of the disclosure, FIG. 4A is an enlarged view corresponding to the right half portion of the air gap in FIG. 2. The winding 120 of the present embodiment is a planar winding, which includes a printed circuit board (PCB) or a copper sheet structure. For example, the PCB winding includes multilayer printed circuit boards. The printed circuit board includes an insulating substrate 122 and a conductive layer 124 thereon. When the winding 120 is conducted, the current passes through the conductive layer 124. Namely, the insulating substrate 122 is the insulating portion of the winding 120, and the conductive layer 124 is the effective conductor portion of the winding 120. More particularly, the conductive layer 124 is the conductor, such as copper, in the PCB winding 120, and the insulating substrate 122 is the support material, such as glass fiber or the like. The conductive layer 124 is disposed on the insulating substrate 122 and is supported by the insulating substrate 122. Also, the insulating substrate 122 isolates the conductive layers 124 of the printed circuit boards. The magnetic piece 130 can be a magnetic film, a magnetic coating, or a substrate having a magnetic material layer. The magnetic piece 130 can be a flexible printed circuit magnetic film. Alternatively, in some embodiments, the magnetic piece 130 can be formed by applying a glue blended with magnetic powders on the printed circuit board or by blending magnetic powders at the predetermined position at the surface of the printed circuit board.

At the dimension parallel to the air gap direction D (see FIG. 2), the distance between the magnetic piece 130 to the middle column 113 is d1, the distance between the magnetic piece 130 to the right column 115 is d2, the length of the magnetic piece 130 is d3, which is the same as the length L in FIG. 2. The distance d1 is regarded as the shortest distance between the magnetic piece 130 and the magnetic core 110 along the dimension parallel to the air gap direction. In some embodiments, the shortest distance is the distance between the magnetic piece 130 and the middle column 113. The winding 120 includes the insulating substrate 122 for isolation and the conductive layer 124 for conduction. The distance between the conductive layer 124 of the winding 120 and the middle column 113 is d4, and the distance between the conductive layer 124 of the winding 120 and the right column 115 is d5. As shown in FIG. 4A, along the dimension parallel to the air gap direction, the same side of the winding 120 and the magnetic piece 130, such as the left side or the right side, are corresponding sides. The ratio of the difference of the shortest distance d1 between magnetic piece 130 and the magnetic core 110 and the distance d4 between the conductive layer 124 of the winding 120 and the corresponding position of the magnetic core 110 to the length d3 of the magnetic piece 130 is preferably less than or equal to 10%, i.e. (d1−d4)/d3≦10%, such that the magnetic piece 130 can provide better result of changing the magnetic field distribution in the window. Namely, the loss of the magnetic component 100 can be highly reduced by placing the magnetic piece 130 under such design conditions.

The situation of (d1−d4)/d3≦10% does not exclude the situation of the shortest distance d1 between the magnetic piece 130 and the magnetic core 110 is less than the distance d4 between the effective conductor portion (e.g. the conductive layer 124) of the winding 120 and the corresponding position of the magnetic core 110, i.e., the situation of d1−d4<0, as shown in FIG. 4B, in which the magnetic piece 130 is more close to the magnetic core 110 than the conductive layer 124 at the corresponding side.

Reference is made to both FIG. 2 and FIG. 4A. In an inductor utilized in the power factor correct circuit of the power of 750 w, the inductance thereof is about 19 μH, the inductor is wounded as the structure illustrated in FIG. 2. The magnetic piece 130 is the flexible printed circuit magnetic film placed on the winding 120. The relative initial permeability of the magnetic piece 130 is about 9, the length is about 1 mm, and the thickness is about 0.2 mm. The distance d1 between the magnetic piece 130 and the middle column 113 is about 0.1 mm. The distance d4 between the conductive layer 124 as the effective conductor portion of the winding 120 and the middle column 113 is about 0.5 mm. The distance between the magnetic piece 130 and the air gap 150 is about 0.1 mm. According to a simulation result, the winding loss of the inductor is reduced from 0.665 w to 0.472 w at 500 kHz, the winding loss is reduced about 29%. Furthermore, the permeability and the length of the magnetic piece 130 are designed, such that the magnetic flux passing through the magnetic piece 130 is controlled. Therefore, the loss of the magnetic piece 130 is tiny, and the effect to the inductance of the inductor is limited.

Besides the planar winding, the winding 120 can be a wire winding using such as enamel wire, silk covered wire, or litz wire, as shown in FIG. 5. In this embodiment, the effective conductor portion 124a is the conductor core, such as copper or aluminum of the wire, and the insulating portion 124b is the enamel or the silk covering the effective conductor portion 124a and provides functions of insulation and/or support. Along the dimension parallel to the air gap direction, the length of the magnetic piece 130 is d3; the shortest distance between the magnetic piece 130 and the magnetic core 110 is d1; the distance between the effective conductor portion 124a of the winding 120 and the corresponding position of the magnetic core 110 is d4, which is the shortest distance of between the effective conductor portion 124a of the winding 120 and the corresponding position of the magnetic core 110. In this embodiment, the design of the magnetic piece 130 still fits the limitation of (d1−d4)/d3≦10%. When the winding 120 is a wire winding, the magnetic piece 130 can be a magnetic film or a substrate applied with a magnetic material layer on the winding 120.

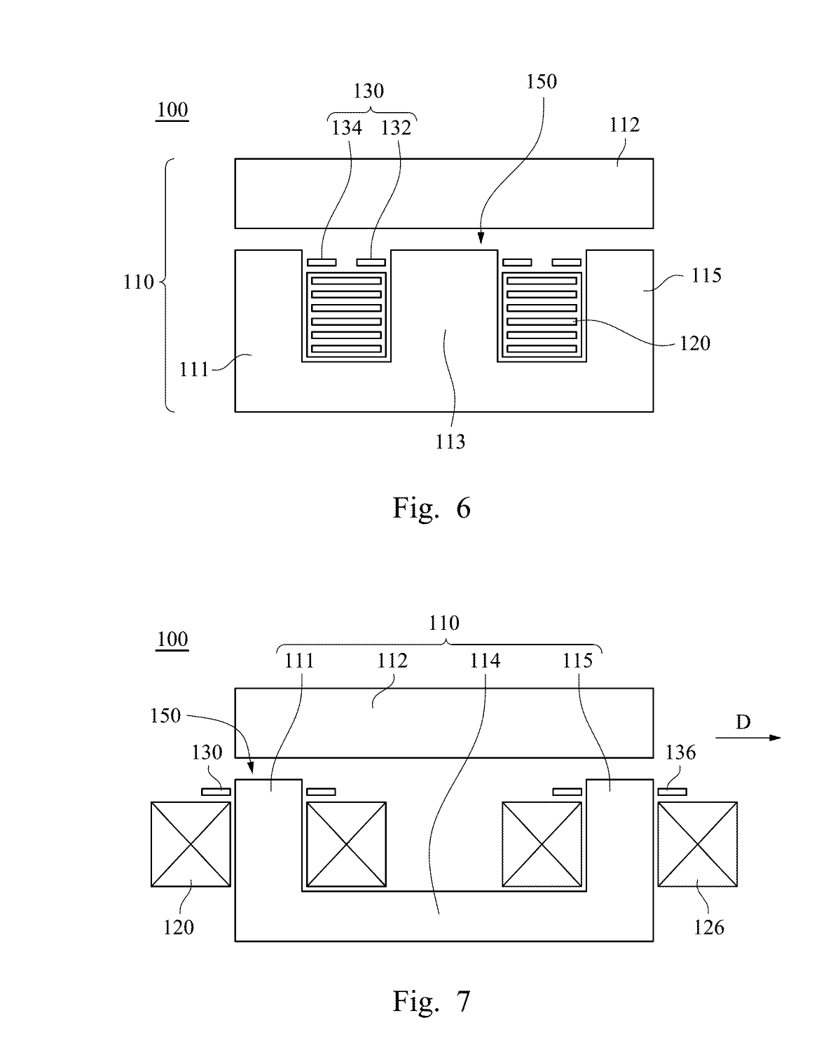

FIG. 6 is a cross-sectional schematic view of another embodiment of the magnetic component taken along the direction parallel to the magnetic flux direction. In this embodiment, the magnetic core 110 is an El type magnetic core, and the winding is a planar winding. The winding 120 is coupled to the middle column 113. The air gap 150 is formed between the top cover 112 and the columns 111, 113, 115. The magnetic piece 130 is disposed between the winding 120 and the air gap 150. The magnetic piece 130 may include two or more ring shape magnetic parts. For example, in this embodiment, the magnetic piece 130 has an inner magnetic ring 132 and an outer magnetic ring 134. The inner magnetic ring 132 and the outer magnetic ring 134 surround the middle column 113. The inner magnetic ring 132 and the outer magnetic ring 134 are arranged at the same level. The size of the inner magnetic ring 132 is smaller than the size of the outer magnetic ring 134, such that the inner magnetic ring 132 is disposed between the middle column 113 and the outer magnetic ring 134. The inner magnetic ring 132 is utilized for reducing the magnetic field intensity near the air gap 150 at the middle column 113 thereby reducing the loss of the winding 120 around the middle column 113. The outer magnetic ring 134 is utilized for reducing the magnetic field intensity near the air gap 150 at the left column 111 and the right column 115 thereby reducing the loss of the winding 120 around the left column 111 and the right column 115.

FIG. 7 is a cross-sectional schematic view of yet another embodiment of the magnetic component taken along the direction parallel to the flux direction. In this embodiment, the magnetic core 110 is a U type magnetic core, which includes a top cover 112, a bottom cover 114, and a left column 111 and a right column 115 connected to the bottom cover 114. An air gap 150 is formed between the top cover 112 and the left column 111 and the right column 115. The magnetic component 100 includes two windings 120, 126. The winding 120 is wound on the left column 111, and the winding 126 is wound on the right column 115. The windings 120 and 126 can be a planar winding, such as a PCB winding or a copper sheet structure winding. The windings 120 and 126 can be wire winding, such as an enamel wire winding, a litz wire winding or other conductive wire winding. The ring shaped magnetic pieces 130 and 136 surround between the air gap 150 and the windings 120 and 126 respectively. The longwise sides of the magnetic pieces 130 and 160 are parallel to the air gap direction D of the air gap 150, in which the air gap direction D is vertical to the in magnetic flux direction. The existent of the magnetic pieces 130 and 136 can uniform the magnetic field intensity in the window. Furthermore, the direction of the magnetic field around the magnetic pieces 130 and 136 is substantially parallel to the air gap direction D, such that the loss of the winding 120 and 126 can be reduced.

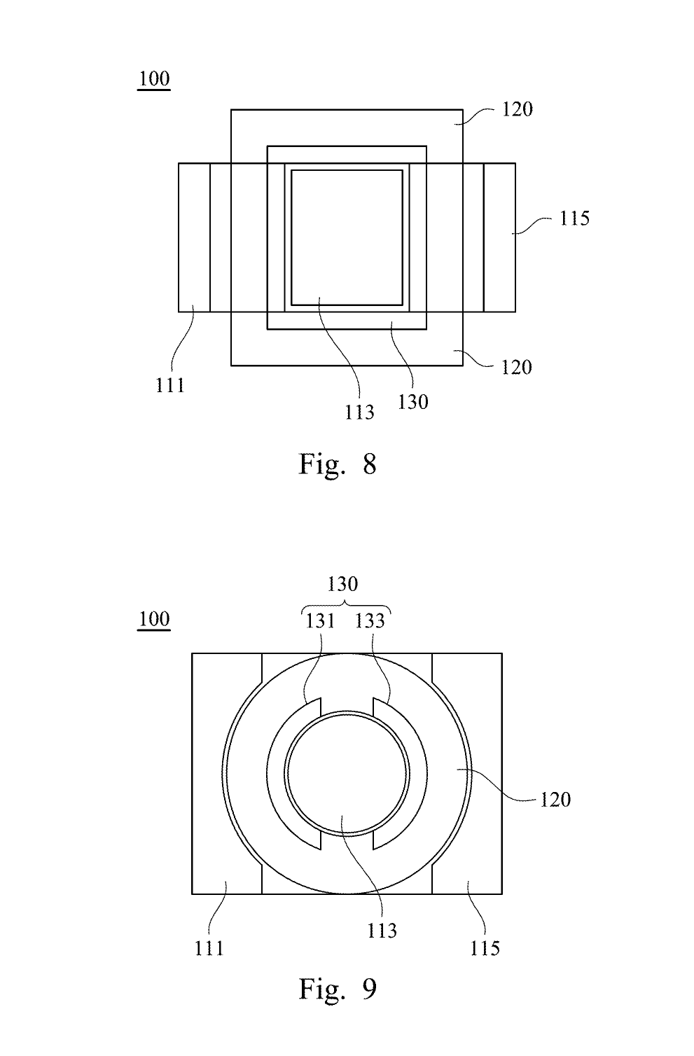

Reference is made to both FIG. 2 and FIG. 8, in which FIG. 8 is a cross-sectional schematic view of the magnetic component 100 of FIG. 2 taken along a direction vertical to the magnetic flux direction. The winding 120 is wound on the middle column 113 and the magnetic piece 130 surrounds the middle column 113, and the magnetic piece 130 is disposed between the air gap 150 and the winding 120. The magnetic piece 130 is a piece with a hole for surrounding the magnetic column. In this embodiment, the shape of the middle column 113 is rectangular, such that the corresponding magnetic piece 130 has a cross-section of rectangular loop, in which the cross-section is taken parallel to the air gap direction D, which is regarded as viewed from the top of the magnetic piece 130. In other embodiments, the cross-section shape of the magnetic piece 130 is designed according to the shape of the magnetic column, such as a ring or an ellipse.

FIG. 9 is a cross-sectional schematic view of another embodiment of the magnetic component taken along the direction parallel to the flux direction. The winding 120 is wound on the middle column 113 and the magnetic piece 130 surrounds the middle column 113. The magnetic piece 130 can be an unclosed piece. For example, the magnetic piece 130 includes a first sub-portion 131 and a second sub-portion 133, the first sub-portion 131 and the second sub-portion 133 are disposed at opposite sides of the middle column 113. The shape of the first sub-portion 131 and the second sub-portion 133 is corresponding to the shape of the middle column 113. For example, the middle column 113 is a cylinder, and the cross-sectional view of the corresponding first sub-portion 131 and the second sub-portion 131 is an arc. In some embodiments, the middle column 113 can be a rectangular column, and the cross-sectional view of the corresponding first sub-portion 131 and the second sub-portion 131 is U-shape. In some embodiments, the magnetic piece 130 can be constructed by more than two sub-portions. Alternatively, the magnetic piece 130 is a substrate applied with a magnetic material layer or a magnetic coating, in which the magnetic material layer or the magnetic coating is applied on the substrate in segments. In some embodiments, the first sub-portion 131 and the second sub-portion 133 are not limited to be disposed at opposite sides of the middle column 113, but can also be arranged surrounding the middle column.

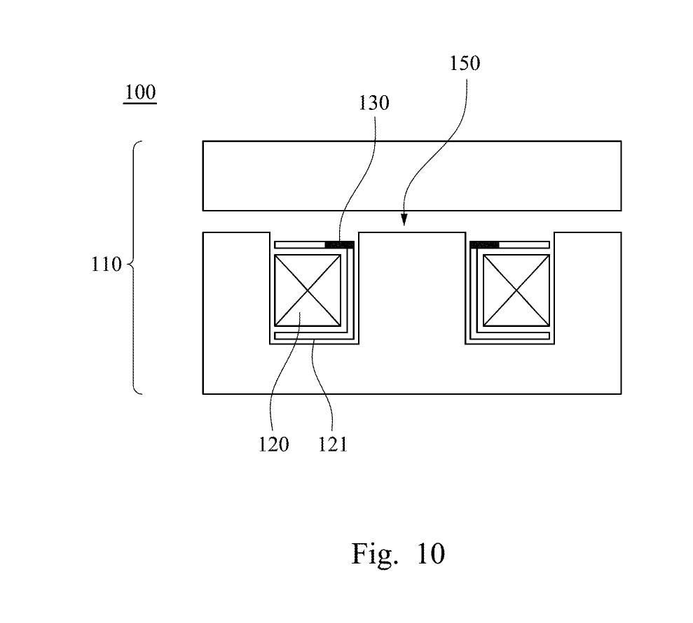

FIG. 10 is a cross-sectional view of yet another embodiment of the magnetic component taken along the direction parallel to the flux direction. The magnetic component 100 includes a magnetic core 110, a winding 120, a bobbin 121, and a magnetic piece 130. The magnetic core 110 is an El type magnetic core. The bobbin 121 is coupled to the middle column 113. The winding 120 is wound on the bobbin 121, and the magnetic piece 130 is disposed between the bobbin 121 and the air gap 150. The bobbin 121 is utilized for supporting the winding 120, and the bobbin 121 is made of non-conductor. In some embodiments, the magnetic piece 130 can be a magnetic film stuck on the bobbin 121. In some embodiments, the magnetic piece 130 is formed by blending magnetic powder at the predetermined position of the bobbin 121, or the magnetic piece 130 is formed by applying the glue having magnetic powder on the bobbin 121.

Although the aforementioned embodiments mainly take the El type magnetic core or U type magnetic core as examples during the description, other types of magnetic cores, such as EE type, ER type, EFD type, PQ type, PJ type, RM type, can type, or the likes, can also be utilized in the disclosure.

The present disclosure provides a magnetic component having a magnetic piece disposed between the air gap and the winding and is parallel to the magnetic air gap direction. The length of the magnetic piece, which is parallel to the air gap direction, is longer than the width of the magnetic piece, which is vertical to the air gap direction. The relative initial permeability of the magnetic piece is greater than 1. The magnetic component can change the magnetic field distribution in the window by adding the magnetic piece between the air gap and the winding, such that the loss of the magnetic component can be reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A magnetic component comprising:
a magnetic core comprising at least one magnetic column, a top cover, and a bottom cover, wherein the magnetic column is disposed between the top cover and the bottom cover, and an air gap is formed between the top cover and the magnetic column;
at least one winding wound on the magnetic column; and
at least one magnetic piece disposed between the winding and the air gap, wherein the magnetic piece is arranged parallel to the air gap.

2. The magnetic component of claim 1, wherein the winding comprises an insulated portion and an effective conductor portion, a minimum distance d1 is defined between the magnetic piece and the magnetic column, a distance d4 is defined between the effective conductor portion and the magnetic column, the magnetic piece has a length d3, wherein a value of (d1−d4)/d3 is less than or equal to 10%.

3. The magnetic component of claim 1, wherein the number of the at least one magnetic column is three, the magnetic columns comprises a left column, a middle column, and a right column; the winding is wound on the middle column, and the magnetic piece is disposed on the winding.

4. The magnetic component of claim 3, wherein the middle column is surrounded by the magnetic piece.

5. The magnetic component of claim 3, wherein the at least one of magnetic piece comprises a first sub-portion and a second sub-portion; the first sub-portion and the second sub-portion are disposed at opposite sides of the middle column.

6. The magnetic component of claim 3, wherein the at least one of magnetic piece comprises an inner magnetic ring and an outer magnetic ring; the middle column is surrounded by the inner magnetic ring and the outer magnetic ring.

7. The magnetic component of claim 1, wherein the at least one magnetic column comprises a left column and a right column, the number of the at least one winding and the at least one magnetic piece is two; wherein the windings are wound on the left column and the right column, and the left column and the right column are surrounded by the magnetic pieces.

8. The magnetic component of claim 1, wherein the number of the least one magnetic column is two, such that a window is defined between the magnetic columns and between the top cover and the bottom cover, wherein a ratio of a length of the magnetic piece to a width of the window is in a range from about 0.1 to about 0.5.

9. The magnetic component of claim 1, wherein the air gap has an air gap length, and a ratio of a thickness of the magnetic piece to the air gap length is in a range from about 0.2 to about 3.

10. The magnetic component of claim 1, wherein the air gap has an air gap length, and a ratio of a vertical distance between the magnetic piece and the air gap to the air gap length is in a range from about 0 to about 5.

11. The magnetic component of claim 1, wherein a length of the magnetic piece is greater than a thickness of the magnetic piece.

12. The magnetic component of claim 1, wherein the winding is a planar winding; the magnetic piece disposed on the planar winding is a magnetic film, a magnetic coating, or a substrate having a magnetic material layer.

13. The magnetic component of claim 1, wherein the winding is a wire winding; the magnetic piece disposed on the wire winding is a magnetic film or a substrate having a magnetic material layer.

14. The magnetic component of claim 1, further comprising a bobbin arranged surrounding the magnetic column, wherein the winding is wound on the bobbin; the magnetic piece disposed on the bobbin is a magnetic film, a magnetic coating, or a substrate having a magnetic material layer.

15. The magnetic component of claim 14, wherein the bobbin is blended with magnetic powder.

16. The magnetic component of claim 1, wherein a relative initial permeability of the magnetic piece is greater than 1.

17. The magnetic component of claim 1, wherein a relative initial permeability of the magnetic piece is in a range between about 5 and about 30.

18. The magnetic component of claim 1, wherein the magnetic piece is a flexible printed circuit magnetic film.

19. The magnetic component of claim 1, wherein a cut plane shape of the magnetic piece is a rectangle, an ellipse, or a rhombus.

20. The magnetic component of claim 1, wherein a cross plane shape of the magnetic piece is a square loop, a circle ring, or an elliptic ring.

21. The magnetic component of claim 1, wherein the air gap has an air gap length; a distance between the magnetic piece and the top cover is larger than or equal to the air gap length.

22. The magnetic component of claim 1, wherein the magnetic core is El type, U type, EE type, ER type, EFD type, PQ type, PJ type, RM type, or can type.
